(19) United States
(12) Patent Application Publication
(10) Pub. No.: US 2002/0156880 A1
(43) Pub. Date: Oct. 24, 2002

(54) Network device managing apparatus, program, information storage medium, and network device managing method

(75) Inventor: Senichi Mokuya, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/106,068

(22) Filed: Mar. 27, 2002

(30) Foreign Application Priority Data
Mar. 27, 2001 (JP) 2001-089427

(51) Int. Cl. G06F 15/173; G09G 5/00

(52) U.S. Cl. 709/223; 345/734

(57) ABSTRACT

The invention provides a network device managing apparatus, a program, an information storage medium, and a network device managing method which allow flexible editing of MIB data. A PC, which manages a network device, includes a data converting unit that converts MIB structure data into XMLMIB structure data in the XML format, and an image generating unit that generates a control panel image based on the XMLMIB structure data and control panel data.

### BACKGROUND OF THE INVENTION

1. Field of Invention

The present invention relates to a network device managing apparatus, a program, an information storage medium, and a network device managing method.

2. Description of Related Art

In the related art, it has been practical to display an MIB (Management Information Base) tree to customize MIB data. However, this customizing approach differs from one network vendor to another, and is inconvenient to users.

### SUMMARY OF THE INVENTION

The reason that this customizing approach differs from one network vendor to another is that MIB data includes standard MIB and extension MIB. The standard MIB is specified, while the extension MIB is freely set by network vendors.

Furthermore, a high degree of knowledge is required to edit MIB data, and many or most users cannot modify the MIB data if they desire to do so.

Moreover, a control panel that is adapted to edit MIB data is fixed, and it is impossible for a user to select a display item of the MIB data or to modify the display order of items.

The present invention addresses the above problems and provides a network device managing apparatus, a program, an information storage medium, and a network device managing method which allow flexible editing of MIB data.

In order to address the foregoing problems, a network device managing apparatus according to the present invention includes: a image generating device which generates an editing image to edit MIB data of network devices; and a data converting device which converts MIB structure data into XMLMIB structure data in the XML format under a predetermined condition. The MIB structure data indicates the location and structure of the MIB data. The image generating device generates the editing image according to the XMLMIB structure data.

A program implementable by a computer according to the present invention includes: an image generating program which generates an editing image to edit MIB data of network devices; and a data converting program which converts MIB structure data into XMLMIB structure data in the XML format under a predetermined condition. The MIB structure data indicates the location and structure of the MIB data. The image generating program generates the editing image based on the XMLMIB structure data.

An information storage medium according to the present invention includes a computer-usable information storage medium that stores the program discussed above.

According to the present invention, the MIB structure data is converted into the XML format data before the editing image is generated, so that the generated editing image can flexibly support variations of data.

In the network device managing apparatus and the program, the editing image may include at least one of an image to switch between displayed and hidden editing items, and an image to change the display order of the editing items.

This allows a user to use the editing image that is convenient to the user, while switching between displayed and hidden editing items or changing the display order of the editing items.

In the network device managing apparatus, the program, and the information storage medium, the data converting device/program may convert the MIB structure data so as to be associated with groups according to a user definition in response to a user request, and the image generating device/program may generate the editing image which can be at least either displayed or edited for each group according to a user definition among the plurality of network devices.

Therefore, a user can display or edit the MIB data for each group defined by the user. This allows a user to efficiently manage the network devices.

In the network device managing apparatus and the program, the data converting device/program may convert the MIB structure data so as to be managed for each type of the network devices, and the editing image may be able to be at least either displayed or edited for each type of the plurality of network devices.

Therefore, a user can display or edit the MIB data for each type of the network devices. This allows a user to efficiently manage the network devices.

A network device managing method according to the present invention includes a network device managing method of managing a plurality of network devices, including the steps of:

prompting a user to select a network device to be managed;

determining whether or not a control panel image to manage the selected network device can be presented; and

generating the control panel image if the control panel image can be presented, or, if the control panel image cannot be presented, prompting the user to enter an item necessary to create the control panel image while presenting an MIB tree image which indicates the location of the MIB data of the plurality of network devices in the tree form.

According to the present invention, by generating an MIB tree image and by prompting a user to enter an item necessary to create a control panel image, data necessary to create the control panel image can be gathered. Furthermore, the location of the MIB data is shown in the tree form, thereby allowing a user to easily trace the target MIB data.

The network device managing method may further include the step of converting the MIB structure data, which indicates the location and structure of the network devices, into the XMLMIB structure data in the XML format in at least one of the cases where a new network device is added and where the MIB data of the network devices is modified.

Therefore, with use of the converted XMLMIB structure data in the XML format, variations of data can be flexibly supported.

The network device managing method may further include the step of, if a modification request of a display item on the control panel image occurs, generating an image which prompts the user to modify at least one of the displayed or hidden item and the displayed order of the display item according to the modification request.

Therefore, a user personally can modify the display item or display order, thereby allowing the user to edit the MIB data in a manner that is comfortable to the user.

Before generating the image which prompts the user to modify, an image which prompts the user to select the image part used to perform the modification may be generated.

Therefore, a user can choose the image part used to modify a display item, thereby allowing the user to modify the display item in a manner that is comfortable to the user. The image part may be implemented by, for example, a list-type image part, a text box type image part, a button type image part, or the like

### BRIEF DESCRIPTION OF THE DRAWINGS

FIG. 1 is a functional block diagram of a network device and a PC according to an example of the present embodiment of the invention;

FIG. 2 is a flowchart of a process sequence according to an example of the present embodiment of the invention;

FIG. 3 is a view of a device-selection image according to an example of the present embodiment of the invention;

FIG. 4 is a view of an MIB tree image according to an example of the present embodiment of the invention;

FIG. 5 is a view of an MIB item registration image according to an example of the present embodiment of the invention;

FIG. 6 is a view of a control panel image according to an example of the present embodiment of the invention; and

FIG. 7 is a view of customizing image according to an example of the present embodiment of the invention.

### DETAILED DESCRIPTION OF PREFERRED EMBODIMENTS

In the following description taken in conjunction with the drawings, the present invention is applied to a PC (personal computer) which functions as a network device managing apparatus to manage a plurality of network devices, by way of example.

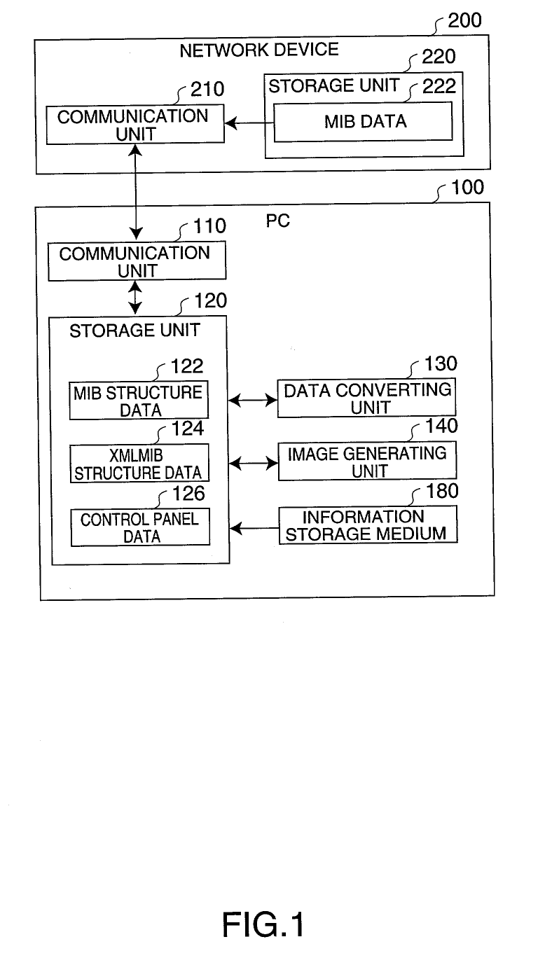

FIG. 1 is a functional block diagram of a network device 200 and a PC 100 according to an example of the present embodiment of the invention.

The network device 200 includes a storage unit 220 which stores MIB data 222, and a communication unit 210 which transmits the MIB data 222 to the PC 100.

The MIB data 222 is data which is made public by a network device which is managed according to the SNMP in order to externally inform the status of the network device. The MIB data 222 is typically referred to as MIB (Management Information Base).

On the other hand, the PC 100 includes a communication unit 110 which communicates with the network device 200, a storage unit 120 which stores MIB structure data 122 and the like, and a data converting unit 130 which converts the MIB structure data 122 into XMLMIB structure data 124 in the XML format if a new network device is added or the specification of the network device is altered, or, otherwise, if the MIB structure data 122 is updated.

The MIB structure data 122 is data indicating the location and structure of the MIB data 222.

The MIB structure data 122 contains items including, for example, the name of item, the data type, the data size, the readability/writability, a description, and link information. The link information of the MIB structure data 122 presents the name of the item one stage above and the item ID of the current item in an MIB tree.

On the other hand, the XMLMIB structure data 124 has items similar to those of the MIB structure data 122, but is different from the MIB structure data 122 in that each piece of information is tagged and is different in view of link information form.

More specifically, the link information in the XMLMIB structure data 124 is expressed, for example, in a form, such as <parent> object ID of upper item </parent> <child> object ID of lower item </child>.

In this way, each piece of information is tagged, and a relationship between an upper item and lower item is clear. Therefore, a result of the control panel data 126 which has been edited by a user is readily reflected to the XMLMIB structure data 124, and it is easy to modify the XMLMIB structure data 124 if there is any change in the configuration and the like of the network device 200.

The PC 100 further includes an image generating unit 140 which generates an editing image to edit the XMLMIB structure data 124 according to the XMLMIB structure data 124 and the control panel data 126 which are stored in the storage unit 120.

With respect to the specific hardware which embodies these components, for example, the communication unit 110 can be implemented as a network card etc., the storage unit 120 as a memory etc., the data converting unit 130 as, for example, a CPU etc., and the image generating unit 140 as an image generating IC etc. These components may be implemented in hardware using a circuit, or may be implemented in software using a program.

For instance, a program which implements the functionalities of the data converting unit 130 and the like may be read from an information storage medium 180 to implement the above-noted functionalities.

The information storage unit 180 can be implemented as a CD-ROM, a DVD-ROM, a ROM, a RAM, an HDD, etc., and its information reading method may be either the contact method or the non-contact method, for example.

Instead of the information storage medium 180, a program that implements each of the above-noted functionalities may be downloaded from a host device through a transmission path to implement each of the above-noted functionalities. That is, a program that implements each of the above-noted functionalities as described above may be embodied on a carrier.

In practice, the PC 100 is connected to a plurality of network devices 200, and the MIB structure data 122, the XMLMIB structure data 124, and the control panel data 126 are prepared for each of the network devices 200.

An editing process sequence for the MIB data 222 using these components is described below.

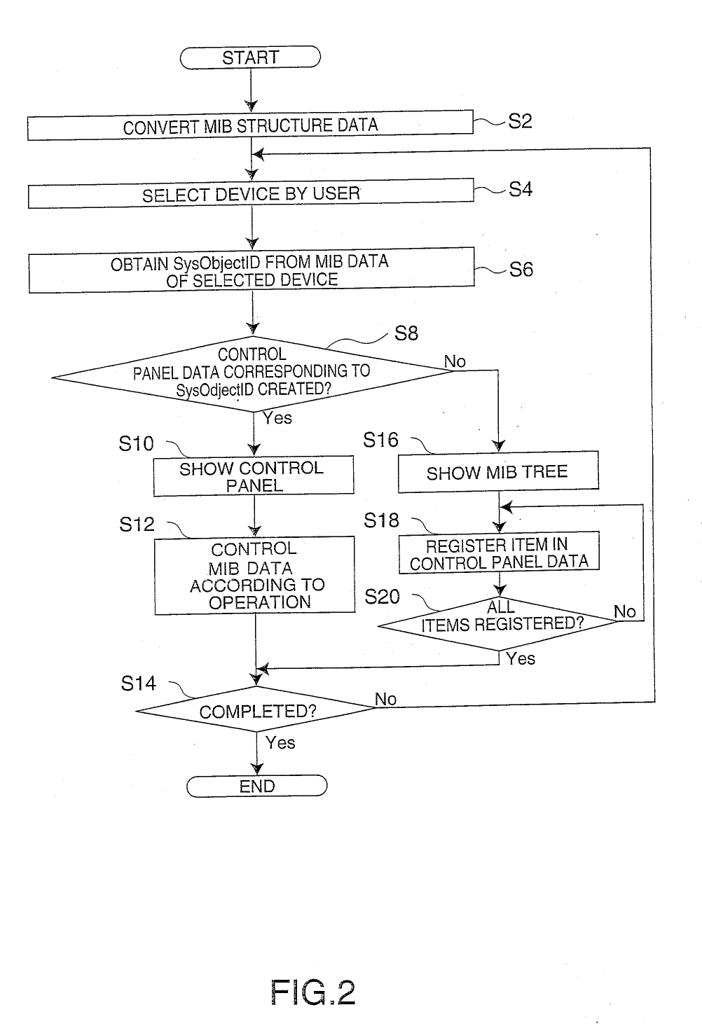

FIG. 2 is a flowchart of a process sequence according to an example of the present embodiment of the invention.

For example, if a new network device 200 is added, the data converting unit 130 converts the MIB structure data 122 into the XMLMIB structure data 124 based on the MIB data 222 retrieved from the network device 200 (step S2).

The image generating unit 140 generates a device-selection image in order to prompt a user to select a network device which is subjected to an editing operation (step S4). The device-selection image is displayed on a display connected to the PC 100.

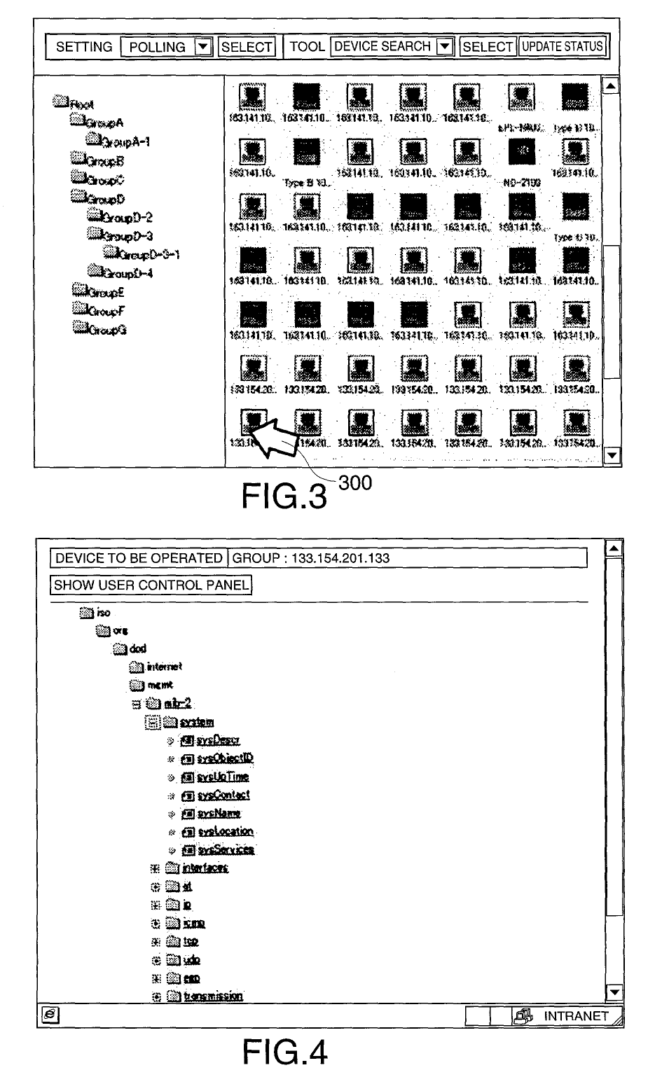

FIG. 3 is a view of a device-selection image according to an example of the embodiment of the invention.

If it is found that a user has selected an icon indicating a desired network device which is subjected to an editing operation by a pointer 300 shown in FIG. 3 using a mouse or the like, the image generating unit 140 retrieves SysObject ID of the MIB data 222 of that network device based on the XMLMIB structure data 124 for that network device (step S6). The SysObjectID is identification information indicating network device types.

Then, the image generating unit 140 checks whether or not the control panel data 126 having the SysObject ID is present in the storage unit 120 (step S8).

If it is the first time, the control panel data 126 having the SysObject ID is not present, and the image generating unit 140 generates an MIB tree image which is one editing image based on the XMLMIB structure data 124 having the SysObject ID. The display shows this MIB tree image (step S16).

FIG. 4 is a view of an MIB tree image according to an example of the present embodiment of the invention.

In the present embodiment, when the XMLMIB structure data 124 is generated (step S2), the XMLMIB structure data 124 is generated so as to be associated with network device types or groups defined by the user as described later. Thus, an MIB tree in the MIB tree image is actually shown for each network device type or for each group defined by the user as described later.

In this manner, since an MIB tree is shown for each device type or for each group defined by a user as described later, the user can efficiently edit the target XMLMIB structure data 124.

The user then selects an item which he desires to edit from the MIB tree.

When detecting this selection action, the image generating unit 140 generates an MIB item registration image to prompt the user to register the item in the control panel data 126 (step S18).

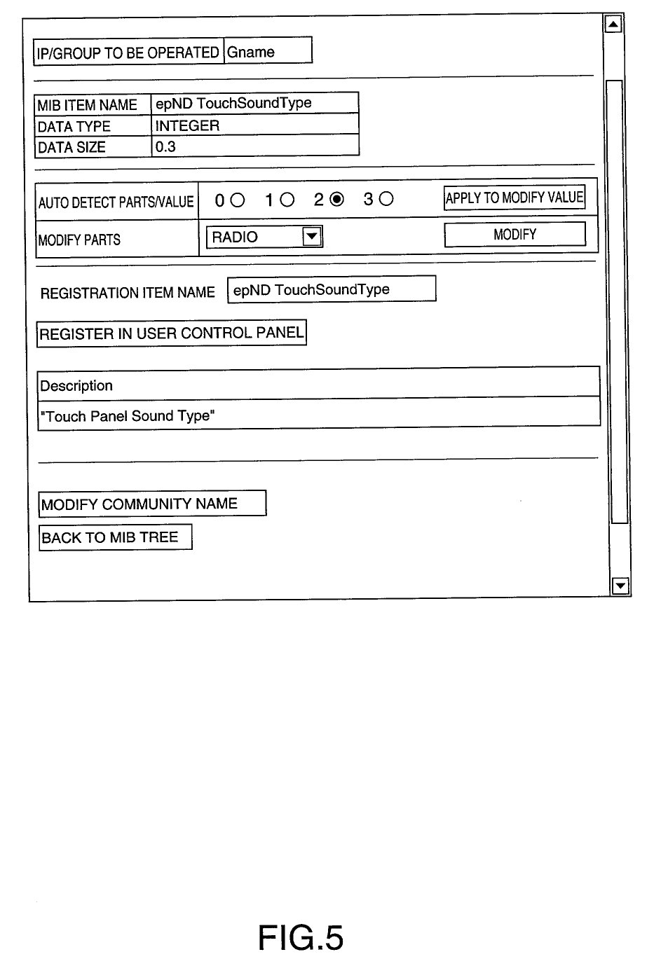

FIG. 5 is a view of an MIB item registration image according to an example of the present embodiment of the invention.

The following are shown on the MIB item registration image: the name of MIB item, the data type and data size of this item, an image to select an image part to be manipulated on a control panel image as described later, and the like.

In the example shown in FIG. 5, a radio-button image part that selects one item from a plurality of items is chosen by a user. Other than a radio-button image part, a text-box, list-box, or a combo-box image part can be chosen by a user.

By selecting “BACK TO MIB TREE” on the MIB item registration image, a user can go back to the MIB tree image shown in FIG. 4 to edit another MIB item.

The image generating unit 140 determines whether or not all the items necessary to create a control panel image have been registered (step S20). If all the items have been registered and the process is not completed (step S14), the image generating unit 140 again performs the process from steps S4 to S8. The item registration (step S18) is performed until all the necessary items have been registered.

If the image generating unit 140 determines that the control panel data 126 having the SysObject ID of interest is present in the storage unit 120 (step S8), it generates a control panel image which is one editing image based on the control panel data 126 having the SysObject ID and the MIB data 222. The display shows this control panel image (step S10).

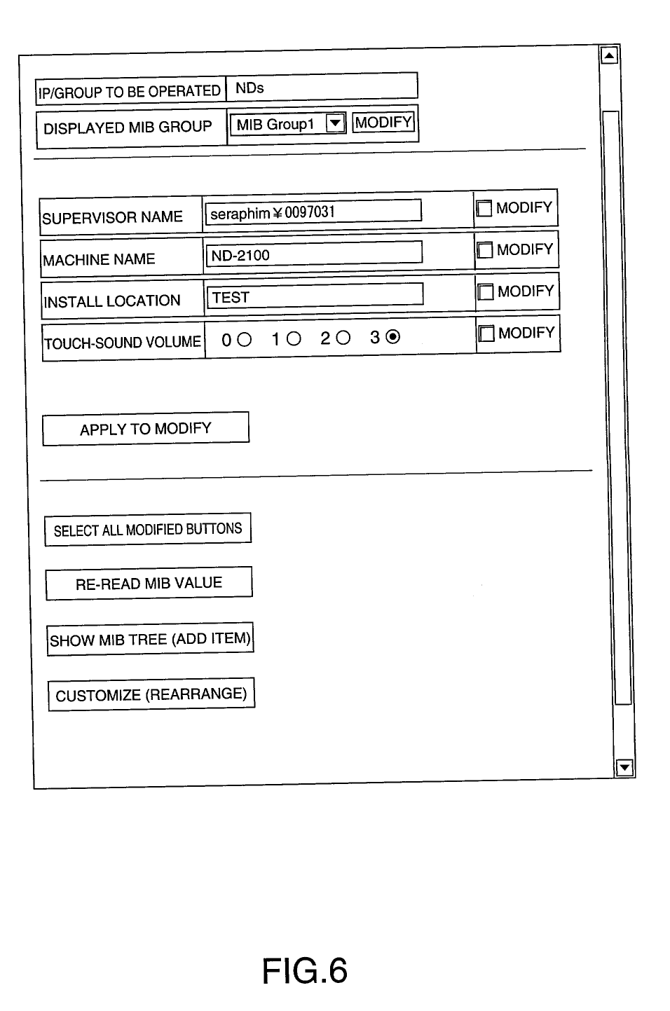

FIG. 6 is a view of a control panel image according to an example of the present embodiment of the invention.

The following are shown on the control panel image: a displayed MIB group, MIB information of the MIB data 222 to be editable, and the like.

In the example shown in FIG. 6, the displayed MIB group indicates “MIBGroup1”, by way of example, and a user can edit the MIB information for each displayed MIB group which was selected.

The MIB information shown in FIG. 6 includes the name of supervisor, the name of machine, the location of installation, the touch-sound volume, and the like. As a user checks the “modify” checkbox right to an item to be modified and clicks the “apply to modify” button, the data converting unit 130 updates the MIB data 222 for the data of the item of interest (step S12). The communication unit 110 transmits the data to be modified to the network device 200, and the network device 200 updates the MIB data 222.

As shown in FIG. 6, since a “radio button” is designated as the selected image part shown in FIG. 5 to select the touch-sound volume, the touch-sound volume shown in FIG. 6 can be selected through the “radio button”.

If it is found that a user has clicked on “customize (modify item)” on the control panel image, then the image generating unit 140 generates a customizing image which is one editing image.

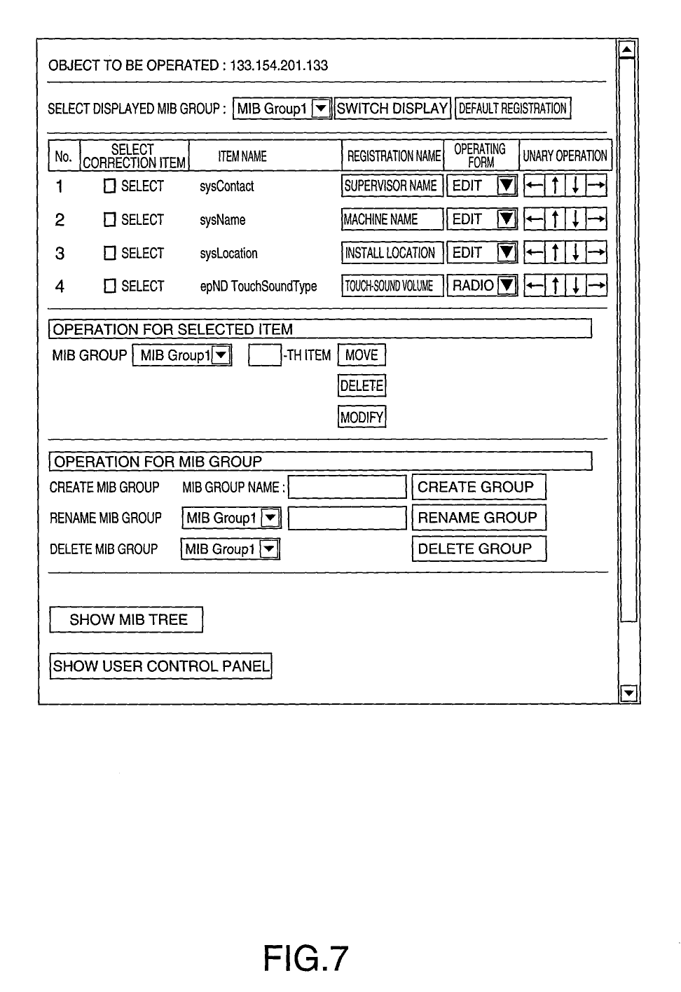

FIG. 7 is a view of a customizing image according to one example of the present embodiment of the invention.

The customizing image includes an image that selects an item to be corrected, an image indicating the name of item, an image indicating the registration name, an image indicating operating types (image part types), an image that moves an item, an image that adds, modifies, and deletes an item, an image that adds, changes, and deletes every MIB group, and the like.

For example, if it is found that an action has been conducted by a user on the image that moves an item to move up a particular item by one stage, the image generating unit 140 generates a customizing image in which the particular item is replaced with the item one stage above, a control panel image, and the like.

When a series of editing operations is completed (step S14), the network device 200 works in the state where the modification is reflected.

As described above, according to the present embodiment, since an editing image is created after the MIB structure data 122 has been converted into the XML format data, an editing image (such as a control panel image) which can flexibly support variations of data can be generated.

Since data is converted into data in a general file format, such as the XML format, the XMLMIB structure data 124 or the MIB data 222 can be edited using a common file editing software application, such as a text editor, for example.

On the customizing image, a user can switch between displayed and hidden editing items or change the display order of the editing items, thereby providing an editing image which is convenient to the user.

On the control panel etc., a user can display or edit MIB information for each group defined by the user.

Furthermore, a user can display or edit MIB information for each network device type.

Therefore, a user can efficiently manage network devices.

Moreover, according to the present embodiment, by generating an MIB tree image and by prompting a user to enter an item necessary to create a control panel image, data necessary to create the control panel image can be gathered. Since the MIB information is shown in the tree form, a user can easily trace the target MIB information.

Furthermore, a user can choose an image part (such as a list-type image part) in order to modify a displayed item, and can modify a displayed item in a manner that is comfortable to the user.

Although the preferred embodiments of the present invention have been described, the present invention is not limited to the above-described embodiments, and a variety of modifications may be made.

For example, the MIB structure data 122 can be converted into data that is not only in the XML format, but also in any of various data formats, such as the CSV, for example. However, presently, the XML format is the most preferable because it is the data format with structured tags and is flexible to modify data.

Specific examples of the above-described network device 200 include a printer, a scanner, and a display terminal, for example.

The features of the present invention may be implemented by not only a unitary device, such as the PC 100, for example, but also may be distributed and implemented by a plurality of devices.

What is claimed is:

1. A network device managing apparatus, comprising:
an image generating device which generates an editing image to edit MIB data of network devices; and
a data converting device which converts MIB structure data into XMLMIB structure data in the XML format under a predetermined condition, the MIB structure data indicating the location and structure of the MIB data, said image generating device generating the editing image according to the XMLMIB structure data.

2. The network device managing apparatus according to claim 1, the editing image including at least one of an image that switches between displayed and hidden editing items, and an image that changes the display order of the editing items.

3. The network device managing apparatus according to claim 1, said data converting device converting the MIB structure data so as to be associated with groups according to a user definition in response to a user request; and
said image generating device generating the editing image which can be at least one of displayed and edited for each group according to a user definition among the plurality of network devices.

4. The network device managing apparatus according to any one of claim 1, said data converting device converting the MIB structure data so as to be associated with the types of the network devices; and
said image generating device generating the editing images which can be at least either displayed or edited for each type of the plurality of network devices.

5. A computer usable program which is implementable by a computer, comprising:
an image generating program which generates an edit image to edit MIB data of network devices; and
a data converting program which converts MIB structure data into XMLMIB structure data in the XML format under a predetermined condition, the MIB structure data indicating the location and structure of the MIB data, said image generating program generating the editing image based on the XMLMIB structure data.

6. The program according to claim 5, the editing image including at least one of an image to switch between displayed and hidden editing items, and an image to change the display order of the editing items.

7. The program according to claim 5, said data converting program converting the MIB structure data so as to be associated with groups according to a user definition in response to a user request; and
said image generating program generating the editing image which can be at least either displayed or edited for each group according to a user definition among the plurality of network devices.

8. The program according to claim 5, said data converting program converting the MIB structure data so as to be associated with the types of the network devices; and
said image generating program generating the editing images which can be at least one of displayed and edited for each type of the plurality of network devices.

9. A computer-usable information storage medium, comprising:
the program according to claim 5.

10. A network device managing method of managing a plurality of network devices, comprising:
prompting a user to select a network device to be managed;
determining whether or not a control panel image that manages the selected network device can be presented to the user; and
generating the control panel image if the control panel image can be presented, and if the control panel image cannot be presented, prompting the user to enter an item necessary to create the control panel image while presenting an MIB tree image which indicates a location of the MIB data of the plurality of network devices in the tree form.

11. The network device managing method according to claim 10, further including the step of converting MIB structure data of the network devices into XML format data in at least one of the cases where a new network device is added and where the MIB data of the network devices is modified.

12. The network device managing method according to claim 10, further comprising the step of, if a modification request of a display item on the control panel image occurs, generating an image which prompts the user to modify at least one of the displayed or hidden item and the displayed order of the display item according to the modification request.

13. The network device managing method according to claim 12, further including, before generating the image which prompts the user to modify, generating an image which prompts the user to select the image part used to perform the modification.
